(19) United States
(12) Patent Application Publication
(10) Pub. No.: US 2009/0029189 A1
(43) Pub. Date: Jan. 29, 2009

(54) IMPRINT MOLD STRUCTURE, AND IMPRINTING METHOD USING THE SAME, AS WELL AS MAGNETIC RECORDING MEDIUM, AND METHOD FOR MANUFACTURING MAGNETIC RECORDING MEDIUM

(75) Inventors: Kenichi MORIWAKI, Kanagawa (JP); Masakazu Nishikawa, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 12/169,870

(22) Filed: Jul. 9, 2008

(30) Foreign Application Priority Data
Jul. 25, 2007 (JP) 2007-193710
Dec. 27, 2007 (JP) 2007-337277

(51) Int. Cl. G11B 9/00

(52) U.S. Cl. 428/826; 425/385; 264/293; 156/345.3

(57) ABSTRACT

The imprint mold structure of the present invention is an imprint mold structure including at least a disc-shaped substrate having a concavo-convex pattern having a plurality of convex portions, wherein the imprint mold structure is used for transferring the concavo-convex pattern onto an imprint resist layer formed on magnetic recording medium substrate, with the concavo-convex pattern of the imprint mold structure being pressed against the imprint resist layer, wherein the shape of a vertical cross-section of the concavo-convex pattern taken on a line having a direction perpendicular to the direction in which the convex portion extends satisfies the following three Mathematical Expressions: (Mathematical Expression 1) 40°≦θ<90°, (Mathematical Expression 2) SRas>SRab, (Mathematical Expression 3) LRah>LRav.

### BACKGROUND OF THE INVENTION

1. Field of the Invention

The present invention relates to an imprint mold structure, and an imprinting method using the imprint mold structure, as well as a magnetic recording medium, and a method for manufacturing the magnetic recording medium.

2. Description of the Related Art

In recent years, hard disc drives that are excellent in speed and cost performance characteristics have begun to be mounted in portable devices such as cellular phones, compact acoustic devices and video cameras as major storage devices.

Furthermore, with increase in market share of hard disc drives as recording devices mounted in portable devices, hard disc drives are requested to meet the demand for further sizing down and increasing capacity, for which it is necessary to develop a technique for increasing recording density.

The recording density of hard disc drives has been conventionally increased by narrowing spaces between data tracks in a magnetic recording medium and by narrowing the magnetic head width.

However, by narrowing spaces between data tracks, effects of magnetism between adjacent tracks (crosstalk) and effects of heat fluctuation become noticeable, thus there is a limitation on improvements in the recording density by the method of narrowing spaces between data tracks.

On the other hand, there is also a limitation on improvements in the surface recording density by the method of narrowing the magnetic head width.

Accordingly, magnetic recording media referred to as discrete track media have been proposed as a solution to noise caused by crosstalk (see Japanese Patent Application Laid-Open (JP-A) Nos. 56-119934 and 02-201730). In the discrete track media, magnetic interference between adjacent tracks is decreased by having discrete structures in which nonmagnetic guard band regions are provided between adjacent tracks so as to magnetically separate tracks from one another.

Also, magnetic recording media referred to as patterned media, in which bits for recording signals are provided in predetermined patterns of shape have been proposed as a solution to demagnetization caused by heat fluctuation (see JP-A No. 03-22211).

As a method for manufacturing the discrete track media and the patterned media, an imprinting method (imprint process) is used in which a desired pattern is transferred onto a resist layer formed on a surface of a magnetic recording medium by using a resist pattern forming mold (otherwise referred to as “stamper”) (see JP-A No. 2004-221465).

The imprinting method is specifically a method of coating a substrate to be processed with a thermosetting resin or a photocurable resin, firmly attaching and pressing a mold that has been processed in a desired pattern to the resin coating the substrate, curing the resin by heating the thermosetting resin or exposing the photo curable resin to light, forming a pattern corresponding to the pattern of the mold on the resin by separating the mold from the resin, and patterning the substrate by dry etching or wet etching using the above pattern on the resist as a mask, to obtain a desired magnetic recording medium.

Incidentally, when a mold is used for manufacturing a magnetic recording medium, since it is necessary to carry out nanoimprint lithography (NIL) finely and for a large area, it becomes important to carry out uniform and stable NIL. In addition, it is necessary to form two types of patterns, that is, a servo signal pattern used for positioning a magnetic head and a data signal pattern used in recording actual data.

A data area is formed of a simple pattern, for example a concentric pattern in the case of a discrete track medium (DTM) or a dotted pattern in the case of a bit patterned medium (BPM).

A servo area is mainly formed of four patterns, that is a preamble, a servo timing mark, an address (sector and cylinder), and a burst. In the address (sector and cylinder) and burst pattern portions, patterns of sparse signals and patterns of dense signals are present in a mixed manner, thereby producing complex pattern arrangements.

Since a complex pattern is densely formed on an entire surface of a disc as described above, accurate transfer of a concavo-convex pattern of a mold structure to an entire surface of an imprint resist layer is required during NIL.

In this imprinting method, since a large number of transfer processes are required in terms of cost reduction, it is necessary for the imprint mold structure to withstand at least several hundreds to several tens of thousands of times of transfer.

Accordingly, in order to improve durability in transfer, a technique in which a rigid body such as a silicon substrate is used in an imprint mold structure has been disclosed (see U.S. Pat. No. 5,772,905 and Appl. Phys. Lett., vol. 67, 3314, 1995 by S. Y. Chou, et al.). According to these literatures, very high pattern accuracy can be obtained, and it is possible to realize transfer of minute patterns including those of submicron size or of the order of several tens of nanometers.

Thus, in order to obtain information recording media such as hard discs and optical discs by the imprint process, it is necessary to obtain very minute and identically shaped mask patterns over the entire surface of the substrate. In particular for a discrete track medium or a patterned medium, a mask pattern is requested in which the pattern is ultrafine and, in terms of obtaining margins in subsequent etching, has large aspect ratios.

Accordingly in an imprint process in order to realize formation of such a minute pattern, it is necessary to satisfy two opposing conditions during manufacture in a balanced manner, one condition is a condition in which a concavo-convex pattern formed on an imprint mold structure is transferred onto an imprint resist with high accuracy, and the other condition is a condition in which the imprint mold structure is separated from the imprint resist without damaging the concavo-convex pattern transferred on the imprint resist.

However, in an imprint process using an imprint resist composition containing a photocurable resin that is cured by exposure to an ultraviolet ray and the like, since the imprint resist composition contracts in volume when it is cured, there is a risk of failure in precisely reflecting a concavo-convex pattern formed on the imprint mold structure in a concavo-convex resist pattern on a substrate of a magnetic recording medium in etching which follows.

To reduce the degree of contraction in volume of the imprint resist composition at the time of curing, a method is proposed in which the surface roughness of wall sides of convex portions of a concavo-convex pattern formed on the imprint mold structure is enlarged to anchor the imprint resist composition. However in this method it is difficult to separate the imprint mold structure from the imprint resist after the imprint resist composition has been cured, which causes damage to the transferred concavo-convex pattern.

Note that JP-A No. 2006-164393 discloses an imprint mold structure including wall sides of convex portions of a concavo-convex pattern having the wall angle in the range of 30° to 80°, which, however, does not provide measures to solve the problem of the contraction of the imprint resist composition in volume at the time of curing the imprint resist composition, leaving room for improvement.

Thus, an imprint mold structure, which has high transferability of a concavo-convex pattern on the mold structure onto an imprint resist and high separability of the mold structure from the imprint resist, and which transfers and forms a high quality pattern on a discrete track medium or a patterned medium with an effect of contraction of the imprint resist composition in volume after the curing of imprint resist being reduced, and the related technology for manufacturing the imprint mold structure, have not been realized yet and have been desired.

### BRIEF SUMMARY OF THE INVENTION

The present invention is carried out in view of such present state of the art, and aims to solve the problems in related art and to achieve the following object. Namely, an object of the present invention is to provide an imprint mold structure, which has excellent transferability of a concavo-convex pattern of the imprint mold structure onto an imprint resist and excellent separability of the imprint mold structure from the imprint resist, which transfers and forms a high quality pattern on a discrete track medium or a patterned medium with an effect of contraction of the imprint resist composition in volume after the imprint resist has been cured being reduced, an imprinting method, a method for manufacturing a magnetic recording medium, and the magnetic recording medium manufactured by the method.

The following are means for solving the aforementioned problems.

<1> An imprint mold structure including at least a disc-shaped substrate having on a surface thereof a concavo-convex pattern having a plurality of convex portions, wherein the imprint mold structure is used for transferring the concavo-convex pattern onto an imprint resist layer formed on a magnetic recording medium substrate, with the concavo-convex pattern of the imprint mold structure being pressed against the imprint resist layer, and wherein the shape of a vertical cross-section of the concavo-convex pattern taken on a line having a direction perpendicular to the direction in which the convex portion extends satisfies the following three Mathematical Expressions:

40°≦θ<90° (Mathematical Expression 1)

SRas>SRab (Mathematical Expression 2)

LRah>LRav (Mathematical Expression 3),

where θ (°) represents a wall angle between a bottom surface of concave portions and a wall side surface of a convex portion in Mathematical Expression 1; SRas represents a surface average roughness of a wall side surface and SRab represents a surface average roughness of a bottom surface of a concave portion in Mathematical Expression 2; LRah represents an average roughness of a wall side surface along a line that has a direction in which the convex portion extends and LRav represents an average roughness of a wall side surface along a line that has a direction perpendicular to the direction in which the convex portion extends.

In the imprint mold structure according to the item <1>, since SRas (surface average roughness of the wall side surface) is larger than SRab (surface average roughness of the bottom surface of a concave portion), the imprint resist layer is anchored so that it is in close contact with the wall side surface in curing carried out after the transfer, which can prevent contraction of the imprint resist layer in volume.

Furthermore, since the wall angle θ between a bottom surface of concave portions and a wall side surface of a convex portion is less than 90°, and since LRah (average roughness of a wall side surface along a line that has a direction in which the convex portion extends) is larger than LRav (average roughness of the wall side surface along a line that has a direction perpendicular to the direction in which the convex portion extends), the imprint mold structure has improved separability from the imprint resist layer, because the shape of a vertical cross-section of the convex portion taken on a line having a direction perpendicular to the direction in which the convex portion extends is tapered, and because the line direction of LRav, line direction on the convex portion perpendicular to the direction in which the convex portion extends, is a direction in which the imprint mold structure slides away from the imprint resist layer and thus the sliding of the imprint mold structure away from the imprint resist layer is promoted by LRav being less than LRah.

<2> The imprint mold structure according to the item <1>, wherein the concavo-convex pattern is composed of at least any one of a first concavo-convex pattern in which a plurality of convex portions are formed in a concentric pattern with its concentric circle center being the substantial center of the disc-shaped substrate and a second concavo-convex pattern in which a plurality of convex portions are formed in a radial direction with its circle center being the substantial center of the disc-shaped substrate.
<3> The imprint mold structure according to any one of the items <1> and <2>, wherein both of the surface average roughness of a wall side surface of a convex portion SRas and the surface average roughness of a bottom surface of a concave portion SRab are in the range of 0.1 nm to 10 nm.
<4> The imprint mold structure according to any one of the items <1> to <3>, wherein both of the average roughness of a wall side surface along a line that has a direction in which the convex portion extends (LRah) and the average roughness of a wall side surface along a line that has a direction perpendicular to the direction in which the convex portion extends (LRav) are in the range of 0.1 nm to 10 nm.
<5> The imprint mold structure according to any one of the items <1> to <4>, wherein the imprint mold structure is made of any one of quartz, nickel, and resin.
<6> A method for imprinting including at least transferring the concavo-convex pattern formed on the imprint mold structure according to any one of the items <1> to <5> onto an imprint resist layer composed of an imprint resist composition formed on a magnetic recording medium substrate, by pressing the imprint mold structure against the imprint resist layer.
<7> A method for manufacturing a magnetic recording medium including at least transferring the concavo-convex pattern formed on the imprint mold structure according to any one of the items <1> to <5> onto an imprint resist layer formed on a magnetic recording medium substrate by pressing the imprint mold structure against the imprint resist layer, forming a magnetic pattern portion corresponding to the concavo-convex pattern on a magnetic layer by etching the magnetic layer formed on a surface of the magnetic recording medium substrate using as a mask the imprint resist layer onto which the concavo-convex pattern has been transferred, and forming a nonmagnetic pattern portion by embedding a nonmagnetic material in a concave portion formed on the magnetic layer.
<8> A magnetic recording medium including at least a magnetic pattern portion and a nonmagnetic pattern portion, wherein the magnetic recording medium is manufactured by the method for manufacturing a magnetic recording medium according to the item <7>.

The present invention can provide an imprint mold structure, which has excellent transferability of a concavo-convex pattern of the imprint mold structure onto an imprint resist and excellent separability of the imprint mold structure from the imprint resist, which transfers and forms a high quality pattern on a discrete track medium or a patterned medium with an effect of contraction of the imprint resist in volume after the imprint resist has been cured being reduced, and an imprinting method with improved precision of transfer realized by using the imprint mold structure, as well as a magnetic recording medium with improved recording property and reproductive property, and a method for manufacturing the magnetic recording medium.

### BRIEF DESCRIPTION OF THE SEVERAL VIEWS OF THE DRAWINGS

FIG. 1 is a partial cross sectional perspective view exemplarily showing the constitution of one embodiment of an imprint mold structure according to the present invention.

FIG. 2A is a cross-sectional view showing an example of a method for manufacturing an imprint mold structure in Examples 1 to 11 and 14 and Comparative Examples 1 to 6.

FIG. 2B is another cross-sectional view showing an example of the method for manufacturing an imprint mold structure in Examples 1 to 11 and 14 and Comparative Examples 1 to 6.

FIG. 3A is a cross-sectional view showing an example of a method for manufacturing an imprint mold structure in Example 12.

FIG. 3B is another cross-sectional view showing an example of the method for manufacturing an imprint mold structure in Example 12.

FIG. 4A is a cross-sectional view showing an example of a method for manufacturing an imprint mold structure in Example 13.

FIG. 4B is another cross-sectional view showing an example of the method for manufacturing an imprint mold structure in Example 13.

FIG. 5 is a cross-sectional view exemplarily showing a method for manufacturing a magnetic recording medium by using an imprint mold structure according to the present invention.

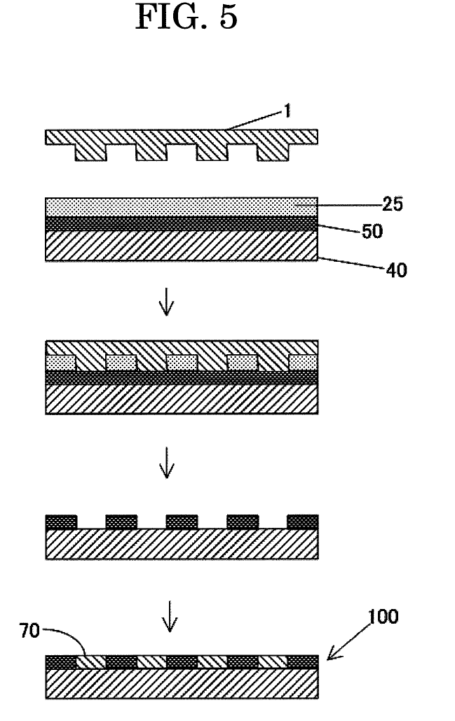

### DETAILED DESCRIPTION OF THE INVENTION

For the following description of the present invention, imprint mold structures for DTM are taken as an example and described with reference to the drawings.

### (Imprint Mold Structure)

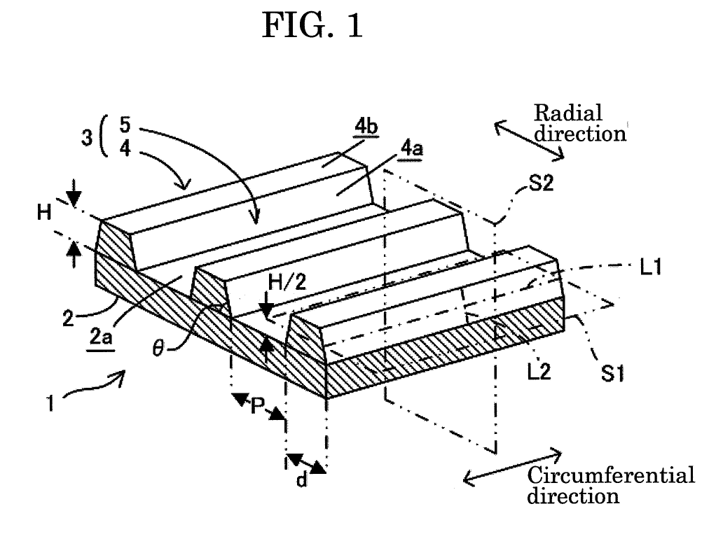

FIG. 1 is a partial cross sectional perspective view showing the constitution of one embodiment of an imprint mold structure according to the present invention.

As shown in FIG. 1, an imprint mold structure 1 of the present embodiment has a plurality of convex portions 4 arranged in a concentric pattern at a predetermined interval on one surface 2a (hereinafter otherwise referred to as “reference surface 2a”) of a disc-shaped substrate 2, and other members as required.

The convex portions are provided correspondingly to servo areas and data areas of the magnetic recording medium. The data areas are composed of a substantially concentric pattern of convex portions and are areas where data are recorded. The servo areas are composed of a plurality of types of convex portions with different areas of convex portions. The servo areas correspond to signals for controlling tracking servo and are mainly composed, for example, of a preamble pattern, a servo timing mark, an address pattern, a burst pattern, or the like. The preamble pattern generates a reference clock signal for reading control signals from an address pattern area or the like. The servo timing mark serves as a trigger signal for reading the address pattern and the burst pattern. The address mark is composed of sector (angle) information and track (radius) information, and provides information on the absolute position (address) on a disc. The burst pattern has a function of finely adjusting the position of the magnetic head and thus enabling highly accurate positioning, when the magnetic head is in a on-track state.

In the description of the present embodiment, convex portions 4 and concave portions 5 formed between a plurality of convex portions 4 are sometimes collectively referred to as a concavo-convex pattern 3.

Specifically, a convex portion 4 is composed of two wall side surfaces 4a tilting toward or away from a surface perpendicular to a radial direction of the substrate 2 at predetermined wall angles to the substrate 2 and a wall top surface substantially parallel to the surface 2a which connects the two wall side surfaces 4a tilted toward each other. Therefore the shape of a vertical cross-section of the convex portion 4 taken on a line having a radial direction of the concentric circles (a direction perpendicular to a direction in which the convex portion extends) is a trapezoid, and preferably an isosceles trapezoid.

For the shape of a vertical cross-section of the convex portion 4, any shape may be selected depending on the purpose, by controlling the etching process described later.

On the other hand, a concave portion 5 is composed of the two wall side surfaces 4a tilting so as to diverge from each other and of the surface 2a.

Hereinafter in the description of the present embodiment, “(shape of) cross-section” indicates, unless otherwise stated, the (shape of) vertical cross-section of a convex portion or a concave portion taken on a line having a radial direction of the concentric circles (a direction perpendicular to a direction in which the convex portion extends).

Furthermore, the substrate 2 preferably is 0.01 mm to less than 1.5 mm in thickness.

In addition, the height H of a convex portion 4 (the depth of a concave portion 5) of the substrate 2 is preferably in the range of 10 nm to 800 nm, and more preferably of 30 nm to 300 nm.

The material for the substrate 2 of the mold structure is not particularly limited and can be appropriately selected depending on the purpose; and preferred material is any one of quartz, a metal, and a resin.

Examples of the metal include various metals such as Ni, Cu, Al, Mo, Co, Cr, Ta, Pd, Pt, Au, and alloys thereof. Among these, Ni and alloys of Ni are particularly preferred.

Examples of the resin include polyethylene terephthalate (PET), polyethylene naphthalate (PEN), polycarbonate (PC), polymehthylmethacrylate (PMMA), cellulose triacetate (TAC), and fluorine resins with low glass transition temperatures.

### —Other Member—

Additional member is not particularly limited and can be appropriately selected depending on the purpose, as long as it does not impair the effects of the present invention; and an example thereof includes a mold surface layer which is formed on the substrate 2 in layer and provides separability from an imprint resist layer.

An imprint mold structure 1 of the present invention preferably satisfies the following Mathematical Expressions (1) to (3), when θ (°) is defined as the wall angle between a surface 2a and a wall side surface 4a of a convex portion 4, SRas is defined as the surface average roughness of the wall side surface 4a, SRab is defined as the surface average roughness of a bottom surface of a concave portion 5 (surface 2a between the two wall side surfaces 4a constituting the concave portion 5), LRah is defined as the average roughness of the wall side surface 4a along a line that has a direction in which the convex portion 4 extends, and LRav is defined as the average roughness of the wall side surface 4a along a line that has a direction perpendicular to the direction in which the convex portion extends:

40°≦θ<90° (Mathematical Expression 1)

SRas>SRab (Mathematical Expression 2)

LRah>LRav (Mathematical Expression 3).

Here, the wall angle θ between a surface 2a and a wall side surface 4a of a convex portion 4, is an inner angle of the trapezoid of the cross-section formed between the surface 2a extending under the convex portion 4 and one of the wall side surfaces 4a which constitutes the convex portion 4 with the other of the wall side surfaces 4a and is facing to the other of the wall side surfaces 4a.

When the wall angle θ is less than 40° in the above Mathematical Expression (1), the pattern formed by the convex portions disposed side-by-side cannot be made fully concentrated and a magnetic layer is patterned relatively sparsely, which results in failure of achieving the object of improving a recording density. If the wall angle θ is 90° or more, when an imprint mold structure is separated from an imprint resist after the imprint resist has been cured, a concavo-convex pattern formed on the imprint mold structure is engaged with a concavo-convex pattern formed on the imprint resist by pressing the concavo-convex pattern formed on the imprint mold structure such that the imprint mold structure cannot be separated from the imprint resist.

For obtaining the surface average roughness of a wall side surface 4a (SRas), the atomic forces acting between the wall side surface 4a and a probe are measured with an AFM (atomic force microscope) for four wall side surfaces constituting two different convex portions 4 and the SRas is represented by the average of these measurements.

The surface average roughness of a wall side surface 4a (SRas) is preferably 0.1 nm to 10 nm.

For obtaining the surface average roughness of a bottom surface of a concave portion 5 (SRab), the atomic forces acting between the bottom surface 2a and a probe are measured with an AFM (atomic force microscope) for two bottom surfaces constituting two different concave portions 5 and the SRab is represented by the average of these measurements.

The surface average roughness of a bottom surface of a concave portion 5 (SRab) is preferably 0.1 nm to 10 nm.

When SRas is equal to SRab or less in the Mathematical Expression (2), an imprint resist is anchored to a bottom surface of the imprint mold structure, and the width of a convex portion of the imprint resist corresponding to the concave portion of the imprint mold structure, which is the most important, is not controlled accurately due to reduction in the volume of the imprint resist when it is cured, which results in decreasing width of a convex portion in a pattern of a magnetic layer, corresponding to the convex portion of the imprint resist, after the magnetic layer has been etched.

The average roughness of a wall side surface 4a along a line that has a direction in which the convex portion 4 extends (LRah) is specifically, as shown in FIG. 1, an average roughness of a wall side surface along a line which is the line L1 of intersection of a plane S1 and the wall side surface 4a (the plane S1 is a plane substantially parallel to the reference surface 2a at a height of half the average height (H/2) of the convex portion 4). The average roughness of a wall side surface 4a along the line can be obtained by extracting data which correspond to data along the line of intersection from data measured for obtaining the surface average roughness of the wall side surface.

The average roughness of a wall side surface 4a along a line that has a direction in which the convex portion 4 extends (LRah) is more preferably 0.1 nm to 10 nm.

The average roughness of a wall side surface 4a along a line that has a direction perpendicular to the direction in which the convex portion 4 extends (LRav) is specifically, as shown in FIG. 1, an average roughness of a wall side surface along a line which is the line L2 of intersection of a plane S2 and the wall side surface 4a (the plane S2 is a plane perpendicular to the reference surface 2a and parallel to the direction perpendicular to the direction in which the convex portion 4 extends (parallel to a radial direction in FIG. 1)). The average roughness of a wall side surface 4a along the line can be obtained by extracting data which correspond to data along the line of intersection from data measured for obtaining the surface roughness of the wall side surface.

The average roughness of a wall side surface 4a along a line (LRav) that has a direction perpendicular to the direction in which the convex portion 4 extends is more preferably 0.1 nm to 10 nm.

When LRah is LRav or less in the above Mathematical Expression (3), the resist pattern may be damaged in a process of separation from an imprint mold structure after the imprint resist composition has been cured, by being caught by the rough in a wall side surface of the imprint mold structure.

As the shape of a concavo-convex pattern provided in an imprint mold structure of the present invention, a shape of a concavo-convex pattern 3 formed along a concentric circumference of a substrate 2 (data pattern) has been exemplified above, a shape of a concavo-convex pattern, convex portions of which are formed along radial directions from the center of the substrate 2 (servo pattern) may also be exemplified as another shape of the concavo-convex pattern.

### (Method for Manufacturing Imprint Mold Structure)

A method for manufacturing an imprint mold structure will be described below with reference to the drawings.

### FIRST EMBODIMENT

### <<Preparation of Master Plate>>

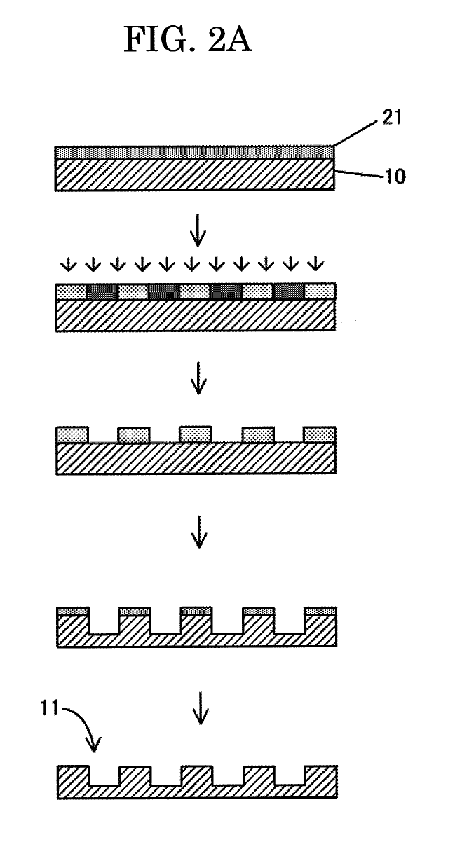

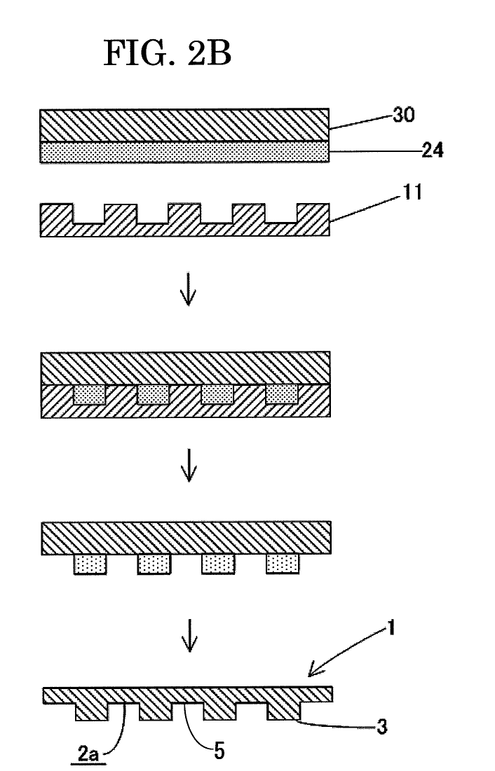

FIGS. 2A and 2B are cross-sectional views showing a method for manufacturing an imprint mold structure. First, as shown in FIG. 2A, a photoresist solution of PMMA, etc. is applied onto a Si substrate 10 by spin coating or the like to form a photoresist layer 21 (photoresist layer forming step).

After that, while the Si substrate 10 is being rotated, a laser beam (or an electron beam) modulated correspondingly to at least any one of a data recording track and a servo signal is applied onto the Si substrate 10 (imaging step).

Here in the imaging step, drawing conditions (specifically, the beam energy, the angle of incident beam, the distribution of beam intensity, and the accuracy of stage movement) are selected in suitable ranges, so that the surface roughness of a wall side surface of the concave portion is made larger than the surface roughness of a bottom surface, at the same time as the average roughness of a wall side surface along a line that has a direction in which the convex portion extends is made larger than the average roughness of the wall side surface along a line that has a direction perpendicular to the direction in which the convex portion extends.

The entire photoresist surface is exposed with predetermined patterns, for example, a data track pattern formed of a pattern of convex portions substantially in the shape of concentric circles, a servo pattern formed of a plurality of different patterns of convex portions with different areas, and a buffer pattern formed of a pattern of convex portions which are radially arranged and continuous in the radial direction between the data track pattern and the servo pattern (exposing step).

Subsequently, the photoresist layer 21 is subjected to a developing process for removal of exposed portions, and the substrate 10 is selectively etched by RIE (reactive ion etching) or the like using as a mask the pattern of the photoresist layer 21 after the removal (etching step) to form a concavo-convex pattern on the substrate 10. Then, a residual resist layer 21 is removed to obtain an master plate 11 having a concavo-convex pattern.

Specifically, no residual resist may be left at the sites of electron beam drawing after the development process and the line edge (bordering to the residual resist) roughness (LER) can be made within 2 nm, by using an electron beam with increasing beam intensity toward the beam center.

Here, the angle θ can be formed in the range of 40° to less than 90°, by selecting the types of etching gas, the mixing ratio thereof, and the conditions for etching (specifically, the process pressure, bias power, and the like) in appropriate ranges in the etching step.

Specifically, the ranges are; the pressure is 0.1 Pa to 10.0 Pa; a rare gas, hydrogen gas, oxygen gas, or the like is introduced to a CF gas; a power of 100 W to 1,000 W is applied for a plasma source, a power of 20 W to 400 W is applied to the substrate. To obtain a more vertical wall angle, the substrate is preferably etched under a low pressure, using a high concentration of gas with which the substrate is sputter etched largely not chemically but physically, such as a rare gas, and with the electric power applied to the substrate being increased.

### <<Preparation of Imprint Mold Structure>>

Next, as shown in FIG. 2B, the master plate 11 is pressed against a quartz substrate 30 to be processed on which an imprint resist solution containing a photocurable resin has been applied for one surface to form an imprint resist layer 24, and a pattern of convex portions formed on the master plate 11 is transferred to the imprint resist layer 24 (transfer step).

### <<Imprint Resist Layer>>

The imprint resist layer is a layer formed by coating the substrate with an imprint resist composition (hereinafter, otherwise referred to as an “imprint resist solution”) containing, for example, at least any one of a thermoplastic resin, a thermosetting resin, and a photocurable resin.

The thickness of the imprint resist layer 24 is preferably 10% to 200% of the height of the convex portions, and more preferably 20% to 150% thereof. The absolute thickness is preferably 10 nm to 100 nm.

The thickness of the imprint resist layer 24 can be measured, for example, by optical measurement using an ellipsometer or by contact measurement using a stylus profilometer, an atomic force microscope (AFM), or the like.

For the imprint resist composition, those having thermoplasticity or photocurability, or a sol/gel or the like can be used. Suitable examples thereof include resins that have those features and high dry etching resistance, such as novolac resins, epoxy resins, and alicyclic resins; and resins having excellent separability, such as fluorine resins.

Here, the material for the substrate 30 to be processed is not particularly limited and can be appropriately selected depending on the purpose, as long as it is a material which transmits light and has the strength necessary for it to function as an imprint mold structure 1; examples thereof include quartz (SiO₂) and organic resins (PET, PEN, polycarbonate, fluorine resins having low glass transition temperatures, and PMMA).

The specific meaning of the expression “transmits light” is that the imprint resist is sufficiently cured when light is applied in such a manner as to enter one surface of the substrate to be processed 30 and exit the other surface thereof covered with the imprint resist layer 24, and that the light transmittance from the one surface to the other surface is 50% or greater.

The specific meaning of the expression “has the strength necessary for it to function as an imprint mold structure” is such strength as enables the material to be separable and to withstand the pressurization when the imprint mold structure is pressed against the imprint resist layer on the substrate of the magnetic recording medium at 4 kgf/cm² in average surface pressure.

### <<Curing Step>>

Thereafter, the transferred pattern is cured by exposing the imprint resist layer 24 to light such as an ultraviolet ray.

### <<Pattern Forming Step>>

Subsequently, the substrate is selectively etched by RIE or the like using as a mask the transferred pattern to obtain an imprint mold structure 1 having a concavo-convex pattern as shown in FIG. 1.

### <<Release Layer Forming Step>>

A release agent layer is formed on the concavo-convex pattern of the mold structure prepared. The release agent layer is preferably formed on the surface of the mold structure so that it enhances the separation of the mold structure from the imprint resist layer at the interface between them after imprinting. The material for the release agent can be appropriately selected, as long as it easily adheres and bonds to the mold structure and is hardly adsorbed by the surface of the imprint resist layer. In particular, fluorine resin is preferred because it is difficult to be adsorbed by the resist layer surface.

Since accuracy of pattern is degraded when the release agent layer is thick, the thickness of the releasing agent layer is preferably as thin as possible; and specifically the thickness is preferably 10 nm or less, and more preferably 5 nm or less.

As a means for forming the release agent layer, coating or vapor deposition can be used. A step for enhancing adsorbability by the mold structure by such a measure as baking may be provided for the releasing agent layer after it has been formed.

### SECOND EMBODIMENT

### <<Preparation of Master Plate>>

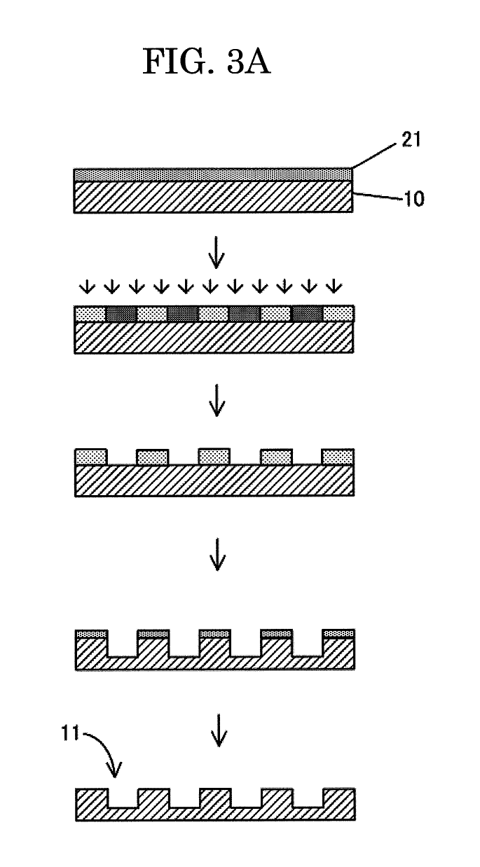

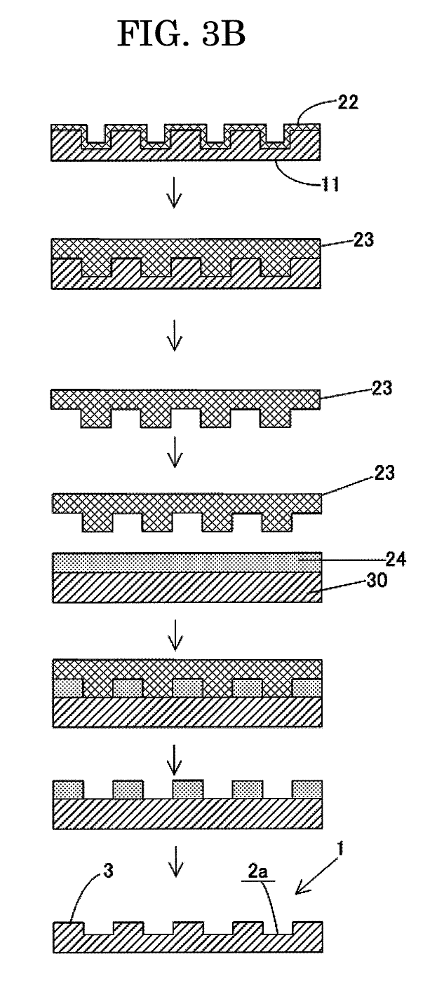

FIGS. 3A and 3B are cross-sectional views showing a method for manufacturing a mold structure according to a second embodiment. An master plate 11 having a concavo-convex pattern is prepared in the same manner as in the first embodiment.

### <<Preparation of Mold Structure>>

A Ni mold structure is prepared by forming a conductive film on the surface of the master plate by sputtering, and immersing the master plate provided with the conductive film in a Ni electroforming bath to electroform a Ni mold structure.

A conductive film 22 can be formed on the concavo-convex pattern of the master plate 11 by processing a conductive material in accordance with a vacuum deposition method such as vacuum vapor deposition, sputtering or ion plating, a plating method, or the like. The conductive material can be appropriately selected depending on a subsequent step (electroforming), and is preferably a Ni-based, Fe-based or Co-based metal/alloy material or the like. The thickness of the Ni mold structure obtained from electroforming is preferably in the range of 20 μm to 800 μm, and more preferably of 40 μm to 400 μm.

### <<Release Layer Forming Step>>

It is preferable to form a release agent layer on the surface of the Ni mold structure in the same manner as in the first embodiment.

### THIRD EMBODIMENT

### <<Preparation of Master Plate>>

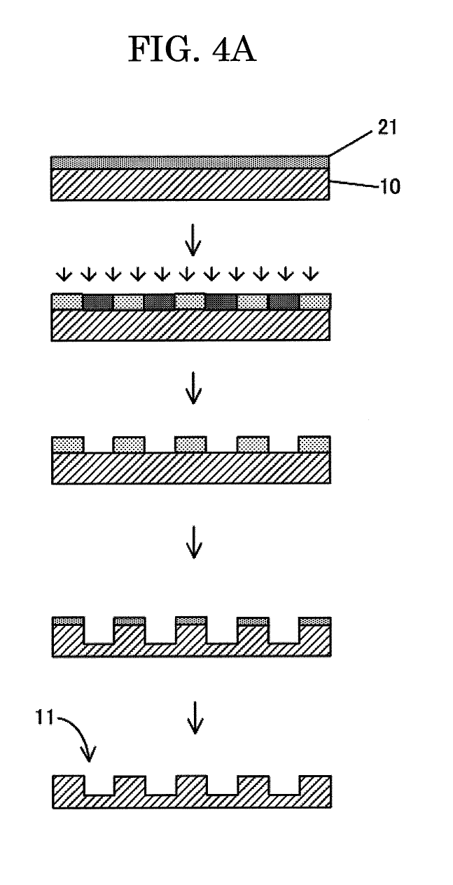

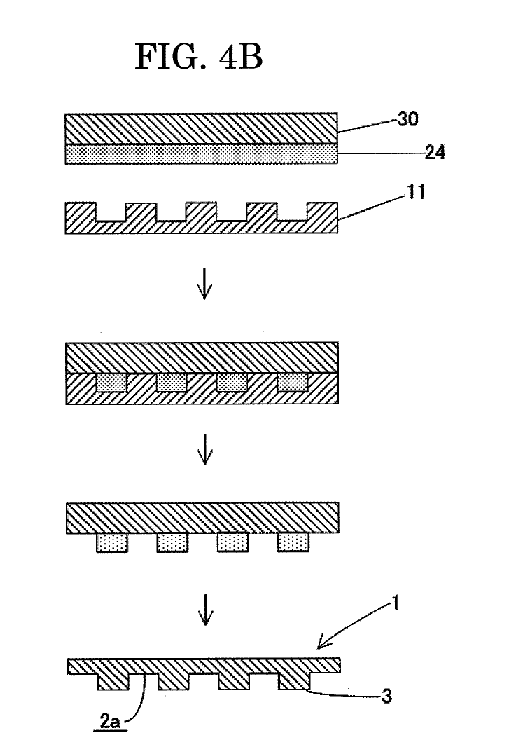

FIGS. 4A and 4B are cross-sectional views showing a method for manufacturing a mold structure according to a third embodiment. An master plate 11 having a concavo-convex pattern is prepared in the same manner as in the first embodiment.

### <<Preparation of Mold Structure>>

The master plate is pressed against a thermoplastic resin sheet. Then the thermoplastic resin sheet with the master plate is heated to a temperature equal to or above the softening point of the resin, which lowers the viscosity of the resin to transfer the pattern of convex portions formed on the master plate onto the thermoplastic resin sheet. Subsequently, a resin mold structure having a concavo-convex pattern is obtained, by curing the transferred pattern by cooling, and separating the resin sheet from the master plate.

Here, the resin material is not particularly limited and can be appropriately selected depending on the purpose, as long as it is a material which has thermoplasticity, optical transparency and a strength to serve as a mold structure; examples thereof include PET, PEN, polycarbonate, fluorine resins having a low glass transition temperature, and PMMA.

The description “a material has optical transparency” specifically means that when a light beam is incident from a certain surface of the substrate to be processed such that the light beam exits from the other surface of the substrate to be processed on which the imprint resist layer has been formed, the imprint resist is sufficiently cured, and means that at least the light transmittance of light beam emitted from the certain surface to the other surface of the substrate is 50% or more.

Further, the description “a material has a strength to serve as a mold structure” means that the material has such a strength that it can bear stress when an imprint mold structure is pressed against an imprint resist layer formed on a magnetic recording medium substrate under the condition of an average surface pressure of 4 kgf/cm² and the imprint resist layer is pressurized.

### <<Release Layer Forming Step>>

It is preferable to form a release agent layer on the surface of the resin mold structure in the same manner as in the first embodiment. A mold structure of the present invention may be appropriately used in an imprinting method including at least a transfer step in which the concavo-convex pattern is transferred onto the resist layer by disposing convex portions of the mold structure so that the convex portions face and are pressed against the resist layer. The mold structure of the present invention is particularly appropriate for a method for manufacturing a magnetic recording medium of the present invention described below.

### <Method for Preparing Magnetic Recording Medium>

The following is a description of a magnetic recording medium prepared by using an imprint mold structure according to the present invention, such as a discrete track medium and a patterned medium, with reference to the drawings. Note that a magnetic recording medium according to the present invention may be one prepared by other manufacturing method than the manufacturing method described below, as long as it is prepared by using the imprint mold structure according to the present invention.

### [Transfer Step]

Onto a substrate made of aluminum, glass, silicon, quartz, or the like, a magnetic layer 50 made of Fe or Fe alloy, Co or Co alloy, or the like is formed to prepare a magnetic recording medium intermediate member. A resist layer 25 is formed on the magnetic layer of the magnetic recording medium intermediate member by applying an imprint resist solution such as polymethylmethacrylate (PMMA). A concavo-convex pattern formed on a mold structure is transferred to the resist layer 25, by pressing, with a pressure, the mold structure on which the concavo-convex pattern is formed against the magnetic recording medium intermediate member with the resist layer.

An imprint resist composition for the imprint resist layer 25 in preparation of a magnetic recording medium may be the same imprint resist composition as used for the imprint resist layer 24 in preparation of an imprint mold structure, as long as it does not impair the accuracy of transfer in a transfer step in preparation of a magnetic recording medium.

Hereinafter, unless otherwise stated, an “imprint resist layer” and an “imprint resist composition” indicate an imprint resist layer 25 in preparation of a magnetic recording medium, and an imprint resist composition forming the imprint resist layer 25, respectively.

### [Curing Step]

### —Cure by Light Exposure—

When the imprint resist composition forming an imprint resist layer 25 contains a photocurable resin, the imprint resist layer 25 is exposed to an ultraviolet ray, an electron beam, or the like via a transparent imprint mold structure 1 to be cured.

### —Cure by Heating—

If the imprint resist composition forming an imprint resist layer contains a thermoplastic resin, when an imprint mold structure 1 is pressed against the imprint resist layer, the temperature of the system is kept in the vicinity of the glass transition temperature (Tg) of the resist solution, and after a pattern is transferred, the imprint resist layer is cured as its temperature becomes lower than the glass transition temperature of the resin solution. Further, as required, the pattern may be exposed to an ultraviolet ray or the like to be cured.

When a concavo-convex pattern is transferred onto an imprint resist layer using the prepared imprint mold structure and is subjected to curing, the ratio of the width of a convex portion of the imprint resist to the width of corresponding concave portion of the imprint mold structure ([width of convex portion of imprint resist]/[width of concave portion of imprint mold structure]) is preferably within the range of 100%±5%.

### [Magnetic Pattern Portion Forming Step]

Next, a magnetic layer is dry etched using as a mask a resist layer onto which a concavo-convex pattern has been transferred, to form a concavo-convex pattern corresponding to the concavo-convex pattern formed on the resist layer.

The method for dry etching is not particularly limited and can be appropriately selected depending on the purpose, as long as it can provide a concavo-convex pattern on a magnetic layer. Examples thereof include ion milling, reactive ion etching (RIE) and sputter etching. Among these, ion milling and reactive ion etching (RIE) are particularly preferable.

The ion milling, also referred to as ion beam etching, is a process of injecting an inert gas such as Ar into an ion source to produce ions, and accelerating these ions through a grid to collide with a sample substrate for etching the sample substrate. Examples of the ion source include Kaufman ion sources, high-frequency ion sources, electron impact ion sources, duoplasmatron ion sources, Freeman ion sources, ECR (electron cyclotron resonance) ion sources, and closed-drift ion sources.

As a process gas in the ion beam etching Ar can be used, as an etchant in the RIE, any one of CO+NH₃, chlorine gas, CF gas, CH gas, mixtures of these gases and oxygen gas, nitrogen gas or hydrogen gas, and the like can be used.

### [Nonmagnetic Pattern Portion Forming Step]

Next, concave portions formed in the magnetic layer are filled with a nonmagnetic material, the surface of the magnetic layer was flattened, and a protective film or the like may be formed on the surface thus formed as required. A magnetic recording medium 100 may be prepared in this way.

Examples of the nonmagnetic material include SiO2, carbon, alumina, polymers such as polymethylmethacrylate (PMMA) and polystyrene (PS), and smooth oils.

The protective film is preferably diamond-like carbon (DLC), sputter carbon, and the like, and a lubricant layer may be further provided on the protective film.

A magnetic recording medium manufactured by a method for manufacturing a magnetic recording medium of the present invention is preferably at least any one of a discrete magnetic recording medium and a patterned magnetic recording medium.

### EXAMPLES

Hereafter, Examples of the present invention will be described, however, the present invention is not limited to the Examples below in any way.

### Example 1

### Preparation of Imprint Mold Structure

### <<Formation of Photoresist Layer>>

As shown in FIG. 2A, an electron beam resist was applied onto an Si substrate 10 of a disc-shaped form by spin coating to form a layer of 100 nm in thickness. The electron beam resist was exposed with a desired pattern by a rotary electron beam exposing apparatus, and then subjected to a developing process to prepare a resist-coated Si substrate having a concavo-convex pattern.

Subsequently, the resist-coated Si substrate was subjected to the following reactive ion etching (RIE) using the resist pattern as a mask to form a concavo-convex pattern on the Si substrate.

Plasma source: ICP (inductively coupled plasma) source

Gas: CF gas with a small amount of hydrogen gas

Pressure: 0.5 Pa

Electric power supplied: 300 W for ICP, 50 W for Bias

Thereafter, a residual resist was removed by washing with a solvent capable of dissolving it, and the Si substrate was dried to prepare a master plate.

Broadly, the pattern used in Example 1 was divided into a data area and a servo area. The data area was formed of a pattern in which a convex portion is 120 nm in width and a concave portion is 30 nm in width (TP=150 nm). The servo area had a servo basic bit length of 90 nm on its innermost circumference and a total sector number of 240 and was formed of a pattern of a preamble (45 bit); a servo mark portion (10 bit); a sector code (8 bit) and a cylinder code (32 bit); and a burst portion.

The servo mark portion employed the number “0000101011”, and the sector code and the cylinder code employed binary conversion and gray conversion, respectively. The burst portion employed a typical phase burst signal (16 bit).

Next, as shown in FIG. 2B, a photocurable acrylic imprint resist solution (PAK-01, manufactured by Toyo Gosei Co., Ltd.) was applied onto a quartz substrate by spin coating to form a layer of 100 nm in thickness. Then the quartz substrate with a photocurable acrylic imprint resist layer was subjected to UV nanoimprinting using the master plate as a mold structure. In the UV nanoimprinting, the pattern was transferred onto the imprint resist layer under a pressure of 1 MPa for 5 sec, then a UV light of 25 mJ/cm² was applied for 10 sec to cure the pattern.

The quartz substrate with the imprint resist layer was selectively etched by RIE indicated below using the concavo-convex resist pattern after nanoimprinting as a mask, to form a concavo-convex pattern on the quartz substrate.

Plasma source: ICP (inductively coupled plasma) source

Gas: 1:1 mixture of CF gas and Ar gas, with a small amount of hydrogen gas

Pressure: 0.5 Pa

Electric power supplied: 300 W for ICP, 60 W for Bias

Thereafter, a residual resist was removed by washing with a solvent capable of dissolving it, and the quartz substrate was dried to prepare a quartz mold.

Note that the quartz substrate was selectively etched such that concave portions 5 of the imprint mold structure 1 having a concavo-convex pattern corresponded to the convex portions 4 in FIG. 1 in shape of cross-section.

### <Formation of Release Layer>

A release agent layer was formed on the concavo-convex pattern of the prepared mold structure by wet process. As the material for the release agent layer, F13-OTCS (tridecafluoro-1,1,2,2-tetrahydro-octyltrichlorosilane) (manufactured by Gelest, Inc.) was used, and a release layer solution (0.1% by mass) was prepared by dissolving it in a solvent ASAHIKLIN AK225 (manufactured by Asahi Glass Co., Ltd.). Using this release layer solution, a release layer of 5.25 nm in thickness was formed on the quartz mold by a Dip method with a lifting speed of 1 mm/sec.

The mold structure on which the release layer had been formed was kept for 5 hr at a temperature of 90° C. and at an RH of 80%, thereby the release layer material was chemically adsorbed by the surface of the mold structure (chemical binding process). The mold structure of Example 1 was thus prepared.

In the following measurement, 5 measurements in each visual field of an atomic force microscope (SPA-500, manufactured by Seiko Instruments Inc.) for line-shaped portions of data areas were averaged. Visual fields were represented by four visual fields taken along a circumference at a radius of 20 mm in an equiangular manner (spaced at a 90 degree angle) per mold structure.

### <<Measurement of Wall Angle θ of Wall Side Surface>>

Samples of cross-section of a mold structure in a radial direction at the above mentioned position were sectioned, and SEM images thereof were photographed. The wall angles were measured for 5 points for 4 visual fields spaced in an equiangular manner on a circumference (5 points per visual field), and the obtained values were averaged.

### <<Measurement of Surface Average Roughness of Wall Side Surface and Bottom Surface of Concave Portion (SRas and SRab)>>

For each of the above mentioned sampling positions of a mold structure, an area of 500 nm square was measured with an AFM. The surface average roughness of a wall side surface and a bottom surface of a concave portion were calculated from data of measurements of the areas in a wall side surface and a bottom surface of a concave portion. For each of the above mentioned sampling positions, 6 areas for AFM measurement were sampled, that is 4 wall side surfaces and two bottom surfaces constituting two different concave portions, and obtained values were averaged.

<<Measurement of Average Roughness of Wall Side Surface Along Line that has Direction in which Convex Portion Extends (LRah) and Along Line that has Direction Perpendicular to the Direction in which Convex Portion Extends (LRav)>>

The average roughness of wall side surface along lines can be obtained by extracting data along a line that has a direction in which the convex portion extends on a wall side surface and data along a line that has a direction perpendicular to the direction in which the convex portion extends on a wall side surface from the AFM data for obtaining the surface average roughness of the wall side surface.

### <Preparation of Magnetic Recording Medium Intermediate Member>

A soft magnetic layer, a first nonmagnetic orientation layer, a second nonmagnetic orientation layer, a magnetic recording layer, and a protective layer were deposited in this order over a 2.5-inch glass substrate in the following manner. The soft magnetic layer, the first nonmagnetic orientation layer, the second nonmagnetic orientation layer, the magnetic recording layer, and the protective layer were formed by sputtering. Additionally, a lubricant layer on the protective layer was formed by a Dip method.

Firstly, as the material for the soft magnetic layer, CoZrNb was sputtered to form a layer of 100 nm in thickness. Specifically, the glass substrate was set facing the CoZrNb target, then Ar gas was injected such that its pressure became 0.6 Pa, and the soft magnetic layer was formed at 1,500 W (DC).

Secondly, as the first nonmagnetic orientation layer, Pt was sputtered to form a layer of 5 nm in thickness. Specifically, the soft magnetic layer formed over the substrate was set facing the Pt target, then Ar gas was injected such that its pressure became 0.5 Pa, and the first nonmagnetic orientation layer was formed at 1,000 W (DC).

Thirdly, as the second nonmagnetic orientation layer, Ru was sputtered to form a layer of 10 nm in thickness. Specifically, the first nonmagnetic orientation layer formed over the substrate was set facing the Ru target, then Ar gas was injected such that its pressure became 0.5 Pa, and the second nonmagnetic orientation layer was formed at 1,000 W (DC).

Fourthly, as the magnetic recording layer, CoPtCr—SiO₂ was sputtered to form a layer of 15 nm in thickness. Specifically, the second nonmagnetic orientation layer formed over the substrate was set facing the CoPtCr—SiO₂ target, then Ar gas was injected such that its pressure became 1.5 Pa, and the magnetic recording layer was formed at 1,000 W (DC).

Lastly, after the formation of the magnetic recording layer, the magnetic recording layer formed over the substrate was set facing a C target, then Ar gas was injected such that its pressure became 0.5 Pa, the protective layer of 4 nm in thickness was formed at 1,000 W (DC). A magnetic recording medium intermediate member was thus prepared. The coercive force of the magnetic recording medium intermediate member thus obtained was 334 kA/m (4.2 kOe).

### <Nanoimprinting and Preparation of Discrete Perpendicular Magnetic Recording Medium>

A photocurable imprint resist solution (a fluorine resin resist, NIF-1, manufactured by Asahi Glass Co., Ltd.) was applied onto the magnetic recording medium intermediate member thus prepared by spin coating to form a layer of 100 nm in thickness.

The above mentioned mold structure was set facing the obtained magnetic recording medium intermediate member with the resist layer. The concavo-convex pattern was transferred onto the resist layer, with the magnetic recording medium intermediate member pressed under a pressure of 1 MPa for 5 sec, then a UV light of 25 mJ/cm² was applied for 10 sec to cure the pattern. Subsequently, the mold structure and the magnetic recording medium intermediate member were separated from each other, and a concavo-convex pattern was thus formed on the resist layer over the magnetic recording medium intermediate member.

Thereafter, using as a mask the imprint resist layer 25 onto which the concavo-convex patterns 3 had been transferred, the magnetic recording medium intermediate member was selectively etched by Ar ion sputter etching (ICP plasma source, Ar gas, 0.2 Pa, ICP/Bias=750 W/300 W); a concavo-convex pattern corresponding to the concavo-convex patterns 3 on the imprint mold structure 1 was formed on the magnetic layer 50; concave portions were filled with a nonmagnetic material 70 (SiO₂ formed by CVD) to flatten the surface of the magnetic layer 50 (by CMP); then a protective layer was formed (a DLC protective layer was formed by CVD) to obtain the magnetic recording medium 100. A discrete perpendicular magnetic recording medium of Example 1 was thus prepared.

### <<Evaluation of Transferability>>

The ratio of the width of a convex portion of an imprint resist to the width of the corresponding concave portion of an imprint mold structure ([width of convex portion of imprint resist]/[width of concave portion of imprint mold structure]) after a concavo-convex pattern has been transferred onto the imprint resist layer using the prepared imprint mold structure and cured, is evaluated according to the following evaluation criteria. The result is shown in Table 1.

### [Evaluation Criteria]

A: the ratio is within the range of 100%±5%
B: the ratio is within the range of 100%±5% to within the range of 100%±10%
C; the ratio is within the range of 100%±more than 10%

### <<Evaluation of Separability>>

The number of the concavo-convex pattern of an imprint resist that became defective when an imprint mold structure was separated from the imprint resist layer after the transfer step, was evaluated as an indicator of separability according to the following evaluation criteria. The result is shown in Table 1.

### [Evaluation Criteria]

A: no defective line in 10 concavo-convex lines of imprint resist
B: one defective line in 10 concavo-convex lines of imprint resist
C: two or more defective lines in 10 concavo-convex lines of imprint resist

### <<Evaluation of Servo Characteristics>>

With respect to the magnetic recording medium prepared in the above preparation of a magnetic recording medium, a position error signal (PES) of a reproduction signal was measured using a magnetic head tester for hard discs (BITFINDER Model-YS 3300, manufactured by IMES Co., Ltd.) having a GMR head of 0.1 μm in reproduction track width and 0.06 μm in reproduction gap, and the position error signal (PES) was evaluated according to the following evaluation criteria. The result is shown in Table 1.

### [Evaluation Criteria]

A: a magnetic recording medium capable of servo tracking, in which the PES was within the range of −10% to 10% of the track width
B: a magnetic recording medium capable of servo tracking, in which the PES was not within the range of −10% to 10% of the track width but within the range of −20% to 20% of the track width
C: a magnetic recording medium incapable of servo tracking

### Examples 2 to 11, Comparative Examples 1 to 6

### <Preparation of Imprint Mold Structure>

Imprint mold structures of Examples 2 to 11 and Comparative Examples 1 to 6 were prepared in the same manner as in Example 1, except that the wall angle θ (°) of a wall side surface, SRas, SRab, LRah, and LRav of the imprint mold structures of Examples 2 to 11 and Comparative Examples 1 to 6 were changed to those with values as shown in Table 1.

### <<Measurement of Wall Angle θ of Wall Side Surface>>

The wall angle θ (°) of a wall side surface of a prepared imprint mold structure was measured in the same manner as in Example 1. The results are shown in Table 1.

### <<Measurement of Surface Average Roughness of Wall Side Surface (SRas)>>

The surface average roughness of a wall side surface (SRas) of a prepared imprint mold structure was measured in the same manner as in Example 1. The results are shown in Table 1.

### <<Measurement of Surface Average Roughness of Bottom Surface of Concave Portion (SRab)>>

The surface average roughness of a bottom surface of a concave portion (SRab) of a prepared imprint mold structure was measured in the same manner as in Example 1. The results are shown in Table 1.

<<Measurement of Average Roughness of Wall Side Surface Along Line that has Direction in which Convex Portion Extends (LRah)>>

For a prepared imprint mold structure, the average roughness of a wall side surface along a line that has a direction in which the convex portion extends (LRah) was measured in the same manner as in Example 1. The results are shown in Table 1.

<<Measurement of Average Roughness of Wall Side Surface Along Line that has Direction Perpendicular to the Direction in which Convex Portion Extends (LRav)>>

For a prepared imprint mold structure, the average roughness of a wall side surface along a line that has a direction perpendicular to the direction in which convex portion extends (LRav) was measured in the same manner as in Example 1. The results are shown in Table 1.

### <Imprint Resist Composition>

For an imprint resist composition, the same composition as used in Example 1 was used.

### <Preparation of Magnetic Recording Medium>

Each of magnetic recording media of Examples 2 to 11 and Comparative Examples 1 to 6 was prepared in the same manner as in Example 1, except that each of imprint mold structures of Examples 2 to 11 and Comparative Examples 1 to 6 was used, respectively, in place of the imprint mold structure of Example 1.

### <<Evaluation of Transferability>>

Prepared imprint mold structures of Examples 2 to 11 and Comparative Examples 1 to 6 were evaluated for transferability in the same manner as in Example 1. The evaluation results are shown in Table 1.

### <<Evaluation of Separability>>

Prepared imprint mold structures of Examples 2 to 11 and Comparative Examples 1 to 6 were evaluated for separability in the same manner as in Example 1. The evaluation results are shown in Table 1.

### <<Evaluation of Servo Characteristics>>

Prepared magnetic recording media of Examples 2 to 11 and Comparative Examples 1 to 6 were evaluated for record reproduction characteristics in the same manner as in Example 1. The evaluation results are shown in Table 1.

### Example 12

### Preparation of Imprint Mold Structure

As shown in FIG. 3B, a conductive film 22 was formed, by sputtering, on a concavo-convex pattern on the surface of an master plate 11 which concavo-convex pattern was prepared in the same manner as in Example 1. Subsequently, the master plate provided with the conductive film 22 was immersed in a Ni electroforming bath of the following composition and a Ni mold structure is electroformed while being rotated at a rotational speed of 50 rpm to 150 rpm, and a Ni plate having a positive concavo-convex pattern of 300 μm in thickness was prepared. Thereafter, the Ni plate was separated from the master plate, a residual resist film was removed, and the Ni plate was washed. A mold structure of Example 12 was thus obtained.

Components and temperature of Ni electroforming bath

| | |
|---|---|
| Nickel sulfamate | 600 g/L |
| Boric acid | 40 g/L |
| Surfactant | 0.15 g/L |
| (sodium lauryl sulfate) | |
| pH = 4.0 | |
| Temperature = 55° C. | |

The wall angle θ (°) of a wall side surface, SRas, SRab, LRah, and LRav of the obtained imprint mold structure 1 are shown in Table 1.

### <<Measurement of Wall Angle θ of Wall Side Surface>>

The wall angle θ (°) of a wall side surface of a prepared imprint mold structure was measured in the same manner as in Example 1. The result is shown in Table 1.

### <<Measurement of Surface Average Roughness of Wall Side Surface (SRas)>>

The surface average roughness of a wall side surface (SRas) of a prepared imprint mold structure was measured in the same manner as in Example 1. The result is shown in Table 1.

### <<Measurement of Surface Average Roughness of Bottom Surface of Concave Portion (SRab)>>

The surface average roughness of a bottom surface of a concave portion (SRab) of a prepared imprint mold structure was measured in the same manner as in Example 1. The result is shown in Table 1.

<<Measurement of Average Roughness of Wall Side Surface Along Line that has Direction in which Convex Portion Extends (LRah)>>

For a prepared imprint mold structure, the average roughness of a wall side surface along a line that has a direction in which the convex portion extends (LRah) was measured in the same manner as in Example 1. The result is shown in Table 1.

<<Measurement of Average Roughness of Wall Side Surface Along Line that has Direction Perpendicular to the Direction in which Convex Portion Extends (LRav)>>

For a prepared imprint mold structure, the average roughness of a wall side surface along a line that has a direction perpendicular to the direction in which convex portion extends (LRav) was measured in the same manner as in Example 1. The result is shown in Table 1.

### <Preparation of Imprint Resist Composition>

For the imprint resist composition of Example 12, as a thermoplastic resin, a novolac resin which has a viscosity of 30 m Pa·s was used.

### <Preparation of Magnetic Recording Medium>

A magnetic recording medium intermediate member was prepared in the same manner as in Example 1.

The above mentioned imprint resist composition was applied onto the magnetic recording medium intermediate member to form a layer of 100 nm in thickness. The mold structure formed of Ni was set facing the obtained magnetic recording medium intermediate member with the resist layer. The concavo-convex pattern was transferred from the mold structure to the resist layer while being heated at 150° C. and pressed against the resist layer under a pressure of 3 MPa for 30 sec and then the concavo-convex pattern on the resist layer was cured by being cooled to 60° C. Subsequently the magnetic recording medium intermediate member was separated from the mold structure to obtain a concavo-convex pattern formed on the resist layer on the magnetic recording medium intermediate member.

Subsequently, the magnetic recording medium intermediate member was etched using as a mask the formed concavo-convex pattern on it to form a concavo-convex pattern on the magnetic recording layer. A perpendicular magnetic recording medium of Example 12 was thus prepared.

### <<Evaluation of Transferability>>

A prepared imprint mold structure of Example 12 was evaluated for transferability in the same manner as in Example 1. The evaluation result is shown in Table 1.

### <<Evaluation of Separability>>

A prepared imprint mold structure of Example 12 was evaluated for separability in the same manner as in Example 1. The evaluation result is shown in Table 1.

### <<Evaluation of Servo Characteristics>>

A prepared magnetic recording medium of Example 12 was evaluated for servo characteristics in the same manner as in Example 1. The evaluation result is shown in Table 1.

### Example 13

A thermoplastic resin layer composed of PMMA on a substrate was set facing the master plate 11 having a concavo-convex pattern prepared in the same manner as in Example 1. The concavo-convex pattern was then transferred from the master plate to the thermoplastic resin layer while being heated at 150° C. and pressed against the master plate under a pressure of 3 MPa for 30 sec. The thermoplastic resin layer with a transferred concavo-convex pattern was cured by being cooled to 60° C., and separated from the master plate and the substrate to obtain a resin mold structure 1 having a concavo-convex pattern.

### <<Measurement of Wall Angle θ of Wall Side Surface>>

The wall angle θ (°) of a wall side surface of a prepared imprint mold structure was measured in the same manner as in Example 1. The result is shown in Table 1.

### <<Measurement of Surface Average Roughness of Wall Side Surface (SRas)>>

The surface average roughness of a wall side surface (SRas) of a prepared imprint mold structure was measured in the same manner as in Example 1. The result is shown in Table 1.

### <<Measurement of Surface Average Roughness of Bottom Surface of Concave Portion (SRab)>>

The surface average roughness of a bottom surface of a concave portion (SRab) of a prepared imprint mold structure was measured in the same manner as in Example 1. The result is shown in Table 1.

<<Measurement of Average Roughness of Wall Side Surface Along Line that has Direction in which Convex Portion Extends (LRah)>>

For a prepared imprint mold structure, the average roughness of a wall side surface along a line that has a direction in which the convex portion extends (LRah) was measured in the same manner as in Example 1. The result is shown in Table 1.

<<Measurement of Average Roughness of Wall Side Surface Along Line that has Direction Perpendicular to the Direction in which Convex Portion Extends (LRav)>>

For a prepared imprint mold structure, the average roughness of a wall side surface along a line that has a direction perpendicular to the direction in which convex portion extends (LRav) was measured in the same manner as in Example 1. The result is shown in Table 1.

### <Imprint Resist Composition>

For the imprint resist composition of Example 13, the same composition as in Example 1 was used.

### <Preparation of Magnetic Recording Medium>

A magnetic recording medium of Example 13 was prepared in the same manner as in Example 1, except that the resin mold structure prepared above was used in place of the imprint mold structure prepared in Example 1.

### <<Evaluation of Transferability>>

A prepared imprint mold structure of Example 13 was evaluated for transferability in the same manner as in Example 1. The evaluation result is shown in Table 1.

### <<Evaluation of Separability>>

A prepared imprint mold structure of Example 13 was evaluated for separability in the same manner as in Example 1. The evaluation result is shown in Table 1.

### <<Evaluation of Servo Characteristics>>

A prepared magnetic recording medium of Example 13 was evaluated for servo characteristics in the same manner as in Example 1. The evaluation result is shown in Table 1.

### Example 14

A mold structure 1 was obtained in the same manner as in Example 1.

### <<Measurement of Wall Angle θ of Wall Side Surface>>

The wall angle θ (°) of a wall side surface of a prepared imprint mold structure was measured in the same manner as in Example 1. The result is shown in Table 1.

### <<Measurement of Surface Average Roughness of Wall Side Surface (SRas)>>

The surface average roughness of a wall side surface (SRas) of a prepared imprint mold structure was measured in the same manner as in Example 1. The result is shown in Table 1.

### <<Measurement of Surface Average Roughness of Bottom Surface of Concave Portion (SRab)>>

The surface average roughness of a bottom surface of a concave portion (SRab) of a prepared imprint mold structure was measured in the same manner as in Example 1. The result is shown in Table 1.

<<Measurement of Average Roughness of Wall Side Surface Along Line that has Direction in which Convex Portion Extends (LRah)>>

For a prepared imprint mold structure, the average roughness of a wall side surface along a line that has a direction in which the convex portion extends (LRah) was measured in the same manner as in Example 1. The result is shown in Table 1.

<<Measurement of Average Roughness of Wall Side Surface Along Line that has Direction Perpendicular to the Direction in which Convex Portion Extends (LRav)>>

For a prepared imprint mold structure, the average roughness of a wall side surface along a line that has a direction perpendicular to the direction in which convex portion extends (LRav) was measured in the same manner as in Example 1. The result is shown in Table 1.

### <Imprint Resist Composition>

For the imprint resist composition of Example 14, the same composition as in Example 12 was used.

### <Preparation of Magnetic Recording Medium>

A magnetic recording medium of Example 14 was prepared in the same manner as in Example 12, except that the imprint mold structure of Example 14 prepared as above was used in place of the mold structure prepared in Example 12.

### <<Evaluation of Transferability>>

A prepared imprint mold structure of Example 14 was evaluated for transferability in the same manner as in Example 1. The evaluation result is shown in Table 1.

### <<Evaluation of Separability>>

A prepared imprint mold structure of Example 14 was evaluated for separability in the same manner as in Example 1. The evaluation result is shown in Table 1.

### <<Evaluation of Servo Characteristics>>

A prepared magnetic recording medium of Example 14 was evaluated for servo characteristics in the same manner as in Example 1. The evaluation result is shown in Table 1.

TABLE 1

| | Wall | | | | | | | | |
|---|---|---|---|---|---|---|---|---|---|
| | angle | | | | | | Size | | Servo |
| | θ (°) | SRas | SRab | LRah | LRav | Material | accuracy | Separability | characteristics |
| Ex. 1 | 70 | 1.2 | 0.8 | 2.4 | 0.9 | Quartz | A | A | A |
| Ex. 2 | 40 | 1.2 | 0.8 | 2.4 | 0.9 | Quartz | A | A | A |
| Ex. 3 | 50 | 1.2 | 1.1 | 2 | 0.9 | Quartz | A | A | A |
| Ex. 4 | 60 | 1.6 | 1.3 | 2.2 | 1.3 | Quartz | A | A | A |
| Ex. 5 | 70 | 5 | 4 | 4 | 0.6 | Quartz | A | A | A |
| Ex. 6 | 70 | 9 | 2 | 7.4 | 1.2 | Quartz | A | A | A |
| Ex. 7 | 70 | 15 | 13 | 16 | 14 | Quartz | A | B | B |
| Ex. 8 | 80 | 1.3 | 1 | 1.9 | 1.6 | Quartz | A | A | A |
| Ex. 9 | 89 | 1 | 0.8 | 1.2 | 0.7 | Quartz | A | A | A |
| Ex. 10 | 85 | 13 | 11 | 18 | 15 | Quartz | A | B | B |
| Ex. 11 | 87 | 8 | 5 | 12 | 7 | Quartz | A | B | B |
| Ex. 12 | 70 | 1.2 | 0.8 | 2.4 | 0.9 | Ni | A | A | A |
| Ex. 13 | 70 | 1.2 | 0.8 | 2.4 | 0.9 | Resin | A | A | A |
| Ex. 14 | 70 | 1.2 | 0.8 | 2.4 | 0.9 | Quartz | A | A | A |
| Comp. | 90 | 1.2 | 0.8 | 2.4 | 0.9 | Quartz | A | C | C |
| Ex. 1 | | | | | | | | | |
| Comp. | 120 | 1.2 | 0.8 | 2.4 | 0.9 | Quartz | A | C | C |
| Ex. 2 | | | | | | | | | |
| Comp. | 70 | 5 | 8 | 2.4 | 0.9 | Quartz | C | A | C |
| Ex. 3 | | | | | | | | | |
| Comp. | 70 | 5 | 0.8 | 0.9 | 3.9 | Quartz | A | C | C |
| Ex. 4 | | | | | | | | | |
| Comp. | 39 | 5 | 2.1 | 3.5 | 1.9 | Quartz | C | A | C |
| Ex. 5 | | | | | | | | | |
| Comp. | 39 | 24 | 30 | 19 | 27 | Quartz | C | C | C |
| Ex. 6 | | | | | | | | | |

As shown in Table 1, the imprint mold structures of Examples 1 to 14 each of which satisfies all of the above stated mathematical expressions (1) to (3) could have higher transferability and better separability than those of Comparative Examples 1 to 6 each of which does not satisfy all of the above stated mathematical expressions (1) to (3).

In addition, by using the imprint mold structures of Examples 1 to 14 each of which satisfy all of the above stated mathematical expressions 1 to 3, magnetic recording media could be provided that have better servo characteristics than the magnetic recording media prepared by using imprint mold structures of Comparative Examples 1 to 6 each of which do not satisfy all of the above stated mathematical expressions 1 to 3.

Further, Examples 1 to 6, 8, 9, and 12 to 14, in each of which SRas and SRab are each in the range of 0.1 nm to 10 nm, could provide imprint mold structures having excellent separability and magnetic recording media having excellent record reproduction characteristics.

Furthermore, Examples 1 to 6, 8, 9, and 12 to 14, in each of which SRas, SRab, LRah, and LRav are each in the range of 0.1 nm to 10 nm, could provide magnetic recording media having excellent record reproduction characteristics.

On the other hand, Comparative Examples 1 and 2, in each of which the average roughness of a wall side surface along a line that has a direction in which the convex portion extends (LRah) was larger than the average roughness of a wall side surface along a line that has a direction perpendicular to the direction in which the convex portion extends (LRav), and in each of which the surface average roughness of a wall side surface (SRas) was larger than the surface average roughness of a bottom surface of a concave portion (SRab), had accordingly excellent transferability, however, had poor separability because the wall angle θ between the surface of a substrate of an imprint mold structure and the wall side surface of a convex portion was 90° or more.

Comparative Example 3, in which the average roughness of a wall side surface along a line that has a direction in which the convex portion extends (LRah) was larger than the average roughness of a wall side surface along a line that has a direction perpendicular to the direction in which the convex portion extends (LRav), had accordingly excellent separability, however, had poor transferability because the surface average roughness of a bottom surface of a concave portion (SRab) was larger than the surface average roughness of a wall side surface (SRas).

Comparative Example 4, in which the wall angle θ between the surface of a substrate of an imprint mold structure and the wall side surface of a convex portion was in the range of 40° to less than 90°, and in which the surface average roughness of a wall side surface (SRas) was larger than the surface average roughness of a bottom surface of a concave portion (SRab), had accordingly excellent transferability, however, had poor separability because the average roughness of a wall side surface along a line that has a direction perpendicular to the direction in which the convex portion extends (LRav) was larger than the average roughness of a wall side surface along a line that has a direction in which the convex portion extends (LRah).

Comparative Example 5, in which the surface average roughness of a wall side surface (SRas) was larger than the surface average roughness of a bottom surface of a concave portion (SRab), and in which the average roughness of a wall side surface along a line that has a direction in which the convex portion extends (LRah) was larger than the average roughness of a wall side surface along a line that has a direction perpendicular to the direction in which the convex portion extends (LRav), had accordingly excellent separability, however, had poor transferability because the wall angle θ between the surface of a substrate of an imprint mold structure and the wall side surface of a convex portion was less than 40°.

Finally Comparative Example 6 had poor transferability and separability because the wall angle θ between the surface of a substrate of an imprint mold structure and the wall side surface of a convex portion was less than 40°, the surface average roughness of a bottom surface of a concave portion (SRab) was larger than the surface average roughness of a wall side surface (SRas), and the average roughness of a wall side surface along a line that has a direction perpendicular to the direction in which the convex portion extends (LRav) was larger than the average roughness of a wall side surface along a line that has a direction in which the convex portion extends (LRah).

Since a minute pattern formed on an imprint mold structure of the present invention efficiently intrudes into an imprint resist layer on a substrate and the imprint mold structure has such constitution that the imprint resist layer is easy to separate from the minute pattern, the imprint mold structure of the present invention can be used in forming a pattern on the substrate with a high yield and is appropriate for preparing discrete media or patterned media.

What is claimed is:

1. An imprint mold structure comprising,
a disc-shaped substrate having on a surface thereof a concavo-convex pattern having a plurality of convex portions,
wherein the imprint mold structure is used for transferring the concavo-convex pattern onto an imprint resist layer formed on a magnetic recording medium substrate, with the concavo-convex pattern of the imprint mold structure being pressed against the imprint resist layer, and
wherein the shape of a vertical cross-section of the concavo-convex pattern taken on a line having a direction perpendicular to the direction in which the convex portion extends satisfies the following three Mathematical Expressions:
40°≦θ<90° (Mathematical Expression 1)
SRas>SRab (Mathematical Expression 2)
LRah>LRav (Mathematical Expression 3),
where θ (°) represents a wall angle between a bottom surface of concave portions and a wall side surface of a convex portion in Mathematical Expression 1; SRas represents a surface average roughness of a wall side surface and SRab represents a surface average roughness of a bottom surface of a concave portion in Mathematical Expression 2; LRah represents an average roughness of a wall side surface along a line that has a direction in which the convex portion extends and LRav represents an average roughness of a wall side surface along a line that has a direction perpendicular to the direction in which the convex portion extends.

2. The imprint mold structure according to claim 1,
wherein the concavo-convex pattern comprises at least any one of a first concavo-convex pattern in which a plurality of convex portions are formed in a concentric pattern with its concentric circle center being the substantial center of the disc-shaped substrate and a second concavo-convex pattern in which a plurality of convex portions are formed in a radial direction with its circle center being the substantial center of the disc-shaped substrate.

3. The imprint mold structure according to claim 1,
wherein both of the surface average roughness of a wall side surface of a convex portion SRas and the surface average roughness of a bottom surface of a concave portion SRab are in the range of 0.1 nm to 10 nm.

4. The imprint mold structure according to claim 1,
wherein both of the average roughness of a wall side surface along a line that has a direction in which the convex portion extends (LRah) and the average roughness of a wall side surface along a line that has a direction perpendicular to the direction in which the convex portion extends (LRav) are in the range of 0.1 nm to 10 nm.

5. The imprint mold structure according to claim 1,
wherein the imprint mold structure is made of any one of quartz, nickel, and resin.

6. A method for imprinting comprising:
transferring a concavo-convex pattern formed on an imprint mold structure onto an imprint resist layer composed of an imprint resist composition formed on a magnetic recording medium substrate, by pressing the imprint mold structure against the imprint resist layer,
wherein the imprint mold structure is an imprint mold structure which comprises
a disc-shaped substrate having on a surface thereof a concavo-convex pattern having a plurality of convex portions,
wherein the shape of a vertical cross-section of the concavo-convex pattern taken on a line having a direction perpendicular to the direction in which the convex portion extends satisfies the following three Mathematical Expressions:
40°≦θ<90° (Mathematical Expression 1)
SRas>SRab (Mathematical Expression 2)
LRah>LRav (Mathematical Expression 3),
where θ (°) represents a wall angle between a bottom surface of concave portions and a wall side surface of a convex portion in Mathematical Expression 1; SRas represents a surface average roughness of a wall side surface and SRab represents a surface average roughness of a bottom surface of a concave portion in Mathematical Expression 2; LRah represents an average roughness of a wall side surface along a line that has a direction in which the convex portion extends and LRav represents an average roughness of a wall side surface along a line that has a direction perpendicular to the direction in which the convex portion extends.

7. A method for manufacturing a magnetic recording medium comprising:
transferring a concavo-convex pattern formed on an imprint mold structure onto an imprint resist layer formed on a magnetic recording medium substrate by pressing the imprint mold structure against the imprint resist layer,
forming a magnetic pattern portion corresponding to the concavo-convex pattern on a magnetic layer by etching the magnetic layer formed on a surface of the magnetic recording medium substrate using as a mask the imprint resist layer onto which the concavo-convex pattern has been transferred, and
forming a nonmagnetic pattern portion by embedding a nonmagnetic material in a concave portion formed on the magnetic layer,
wherein the imprint mold structure is an imprint mold structure which comprises:
a disc-shaped substrate having on a surface thereof a concavo-convex pattern having a plurality of convex portions,
wherein the shape of a vertical cross-section of the concavo-convex pattern taken on a line having a direction perpendicular to the direction in which the convex portion extends satisfies the following three Mathematical Expressions:
40°≦θ<90° (Mathematical Expression 1)
SRas>SRab (Mathematical Expression 2)
LRah>LRav (Mathematical Expression 3),
where θ (°) represents a wall angle between a bottom surface of concave portions and a wall side surface of a convex portion in Mathematical Expression 1; SRas represents a surface average roughness of a wall side surface and SRab represents a surface average roughness of a bottom surface of a concave portion in Mathematical Expression 2; LRah represents an average roughness of a wall side surface along a line that has a direction in which the convex portion extends and LRav represents an average roughness of a wall side surface along a line that has a direction perpendicular to the direction in which the convex portion extends.

8. A magnetic recording medium comprising:
a magnetic pattern portion and
a nonmagnetic pattern portion,
wherein the magnetic recording medium is manufactured by a method for manufacturing a magnetic recording medium which comprises,
transferring a concavo-convex pattern formed on an imprint mold structure onto an imprint resist layer formed on a magnetic recording medium substrate by pressing the imprint mold structure against the imprint resist layer,
forming the magnetic pattern portion corresponding to the concavo-convex pattern on a magnetic layer by etching the magnetic layer formed on a surface of the magnetic recording medium substrate using as a mask the imprint resist layer onto which the concavo-convex pattern has been transferred, and
forming the nonmagnetic pattern portion by embedding a nonmagnetic material in a concave portion formed on the magnetic layer,
wherein the imprint mold structure is an imprint mold structure which comprises:
a disc-shaped substrate having on a surface thereof a concavo-convex pattern having a plurality of convex portions,
wherein the shape of a vertical cross-section of the concavo-convex pattern taken on a line having a direction perpendicular to the direction in which the convex portion extends satisfies the following three Mathematical Expressions:
40°≦θ<90° (Mathematical Expression 1)
SRas>SRab (Mathematical Expression 2)
LRah>LRav (Mathematical Expression 3),
where θ (°) represents a wall angle between a bottom surface of concave portions and a wall side surface of a convex portion in Mathematical Expression 1; SRas represents a surface average roughness of a wall side surface and SRab represents a surface average roughness of a bottom surface of a concave portion in Mathematical Expression 2; LRah represents an average roughness of a wall side surface along a line that has a direction in which the convex portion extends and LRav represents an average roughness of a wall side surface along a line that has a direction perpendicular to the direction in which the convex portion extends.
